(19) United States
(12) Patent Application Publication
(10) Pub. No.: US 2024/0360980 A1
(43) Pub. Date: Oct. 31, 2024

(54) PLANAR ILLUMINATION DEVICE

(71) Applicant: MINEBEA MITSUMI Inc., Nagano (JP)

(72) Inventors: Yusuke NARA, Kitasaku-gun (JP); Takahito YOSHIDA, Kitasaku-gun (JP)

(21) Appl. No.: 18/571,842

(22) PCT Filed: Mar. 18, 2022
(86) PCT No.: PCT/JP2022/012691

§ 371 Date: Dec. 19, 2023

(30) Foreign Application Priority Data
Jun. 28, 2021 (JP) 2021-106666
Aug. 30, 2021 (JP) 2021-139887

(51) Int. Cl. F21V 7/00; F21V 7/04; F21Y 105/16

(52) U.S. Cl. CPC F21V 7/0083; F21V 7/0066; F21V 7/048; F21Y 2105/16

(57) ABSTRACT

A planar illumination device of an embodiment includes a plurality of light sources, a substrate, and a reflector. The light sources are bidimensionally disposed on the substrate. The reflector is provided with a segment including a hole corresponding to each of the light sources and a reflecting surface extending obliquely from a periphery of the hole, is provided with outer walls at an entire outer peripheral portion of the reflector, and is disposed at an emission side of the substrate. In the segment disposed at an irregular portion of an outer peripheral portion of the reflector and unconfigurable into a predetermined shape by the outer walls, surfaces of the outer walls opposing the substrate are provided with recessed portions for accommodating the light sources or adjusting the amount of light.

### CROSS-REFERENCE TO RELATED APPLICATIONS

This application is a national stage entry of International Application No. PCT/JP2022/012691, filed on Mar. 18, 2022, which claims priority to Japanese Patent Application Numbers 2021-106666 and 2021-139887, filed on Jun. 28, 2021 and Aug. 30, 2021, respectively, which are incorporated herein by reference.

### TECHNICAL FIELD

The disclosure relates to a planar illumination device.

### BACKGROUND

A direct-type planar illumination device with light sources such as light emitting diodes (LEDs) bidimensionally disposed on a substrate often uses a reflector to reflect light emitted from the light sources in a direction oblique to a normal direction of the substrate and increase light in the normal direction of an emission surface (see, for example, JP 2021-12884 A).

The reflector has a unit structure called a segment provided for an individual light source, and each segment includes a hole and a reflecting surface extending obliquely from the periphery of the hole and surrounding the light source. A head (light-emitting portion) of the individual light source is inserted into the hole. The segment is often formed in a regular shape such as a rectangle or a hexagon in a plan view.

### SUMMARY

However, for a planar illumination device having an irregular outer shape such as a non-rectangular outer shape, a segment having a predetermined shape (standard segment) cannot be formed at an outer peripheral portion of an irregular portion, thus the segment is not arrangeable, and an incomplete region may be left. In this case, a small region where no light source is arrangeable can be ignored, but when an outer wall provided at an outer peripheral portion of the reflector for providing strength or the like becomes an obstacle to cause a light source to not be arrangeable, the remaining region has an unignorable size. As a result, the luminance of the outer peripheral portion of the irregular portion decreases to form a dark portion.

In light of the foregoing, the disclosure is directed at providing a planar illumination device even when the planar illumination device has an irregular outer shape. The planar illumination device allows a dark portion to be less likely to be formed.

To solve the problem described above and achieve the object, a planar illumination device according to an aspect of the disclosure includes a plurality of light sources, a substrate, and a reflector. The light sources are bidimensionally disposed on the substrate. The reflector is provided with a segment including a hole corresponding to each of the light sources and a reflecting surface extending obliquely from a periphery of the hole, is provided with outer walls at an entire outer peripheral portion of the reflector, and is disposed at an emission side of the substrate. In the segment disposed at an irregular portion of an outer peripheral portion of the reflector and unconfigurable into a predetermined shape by the outer walls, surfaces of the outer walls opposing the substrate are provided with recessed portions for accommodating the light sources or adjusting an amount of light.

A planar illumination device according to an aspect of the disclosure allows a dark portion to be less likely to be formed even when the planar illumination device has an irregular outer shape.

### BRIEF DESCRIPTION OF DRAWINGS

FIG. 1 is a perspective view of a planar illumination device according to a first embodiment.

FIG. 2 is an exploded perspective view of the planar illumination device.

FIG. 3 is an enlarged perspective view of the vicinity of a cutout portion of a reflector.

FIG. 4 is an enlarged perspective view of the vicinity of the cutout portion of the reflector viewed from another viewpoint.

FIG. 5 is a view from a direction facing an emission surface in the vicinity of the cutout portion of the planar illumination device.

FIG. 6 is a perspective view illustrating an example provided with recessed portions without extending through an outer wall of the reflector.

FIG. 7 is a perspective view of a planar illumination device according to a second embodiment.

FIG. 8 is an exploded perspective view of the planar illumination device.

FIG. 9 is an enlarged perspective view of the vicinity of a cutout portion of a reflector.

FIG. 10A is a plan view illustrating the vicinity of the cutout portion of the planar illumination device.

FIG. 10B is a view illustrating an example of a luminance distribution of the planar illumination device in FIG. 10A.

FIG. 11A is a plan view illustrating the vicinity of a cutout portion of a planar illumination device in a comparative example (modified example).

FIG. 11B is a view illustrating an example of a luminance distribution of the planar illumination device in FIG. 11A.

FIG. 12A is a plan view illustrating the vicinity of a cutout portion of a planar illumination device according to a third embodiment.

FIG. 12B is a view illustrating an example of a luminance distribution of the planar illumination device in FIG. 12A.

FIG. 13 is a perspective view illustrating the vicinity of a cutout portion of a planar illumination device according to a fourth embodiment.

FIG. 14 is a plan view of a planar illumination device according to a fifth embodiment.

FIG. 15A is a plan view illustrating an example when a rotation angle of a light source of the planar illumination device in a plane is 0°.

FIG. 15B is a view illustrating characteristics of a luminance distribution in the arrangement of FIG. 15A.

FIG. 16A is a plan view illustrating an example when the rotation angle of the light source of the planar illumination device in the plane is 45°.

FIG. 16B is a view illustrating characteristics of a luminance distribution in the arrangement of FIG. 16A.

FIG. 17 is a plan view illustrating an example when rotation angles of all light sources of the planar illumination device in a plane are 0°.

FIG. 18 is a plan view illustrating an example when the rotation angles of all the light sources of the planar illumination device in the plane are 45°.

FIG. 19 is a plan view illustrating an example when the rotation angles of light sources at corner portions of the whole planar illumination device in the plane are 0° and the rotation angles of the other light sources in the plane are 45°.

FIG. 20 is a plan view (1) illustrating an example of the shape of a reflecting surface of a segment of the reflector.

FIG. 21 is a plan view (2) illustrating an example of the shape of the reflecting surface of the segment of the reflector.

FIG. 22 is a plan view (3) illustrating an example of the shape of the reflecting surface of the segment of the reflector.

FIG. 23 is a plan view (4) illustrating an example of the shape of the reflecting surface of the segment of the reflector.

### DESCRIPTION OF EMBODIMENTS

A planar illumination device according to embodiments is described below with reference to the drawings. Further, the disclosure is not limited to the embodiment. Furthermore, the dimensional relationships between elements, proportions of the elements, and the like in the drawings may differ from reality. The drawings may include parts having mutually different dimensional relationships and proportions. Furthermore, the contents described in one embodiment or modified examples are applied in principle to other embodiments or modification examples.

### First Embodiment

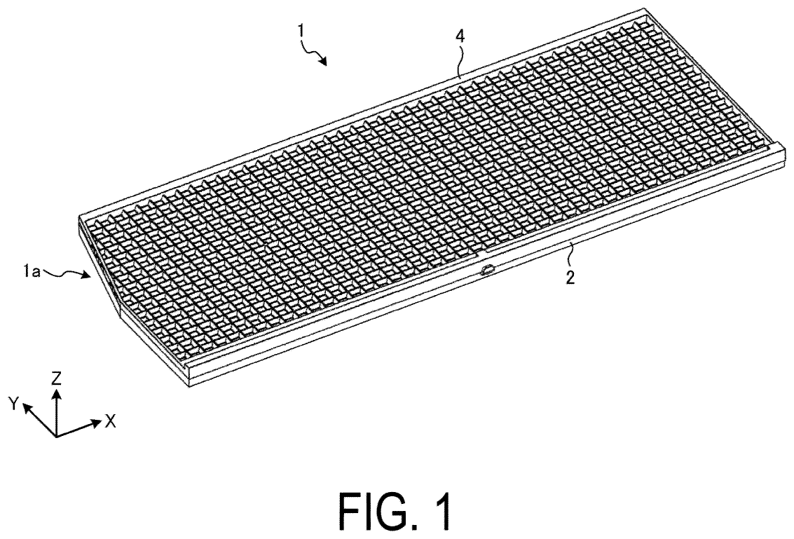

FIG. 1 is a perspective view of a planar illumination device 1 according to a first embodiment. For the sake of convenience, a longitudinal direction of the planar illumination device 1 is an X-axis direction, a lateral direction is a Y-axis direction, and a thickness direction is a Z-axis direction, but an orientation during use is arbitrary.

In FIG. 1, the planar illumination device 1 includes a substrate 2 and a reflector 4 fixed to an upper side of the substrate 2 in the drawing by a double-sided tape or the like. A cutout portion 1a is provided at the left side of the substrate 2 and the reflector 4 in the drawing to form an irregular outer shape. The irregular outer shape may not only be chipped in a linear shape like the cutout portion 1a but also be chipped in an arc shape or in a complicated shape.

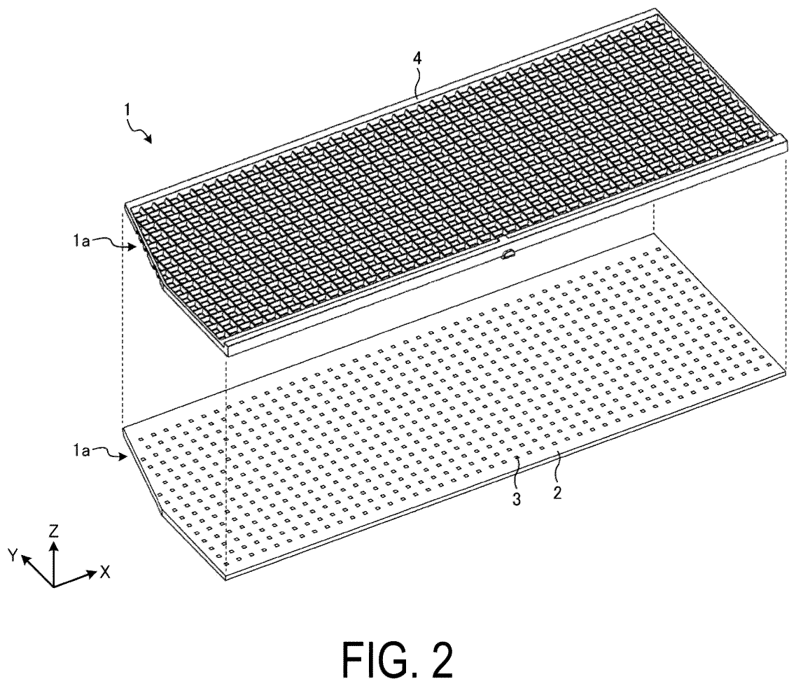

FIG. 2 is an exploded perspective view of the planar illumination device 1. In FIG. 2, light sources 3 such as light-emitting diodes (LEDs) are bidimensionally disposed on the substrate 2, and wiring (not illustrated) to each light source 3 is also provided. Although the substrate 2 and the reflector 4 each have a flat plate shape in the illustrated example, the substrate 2 and the reflector 4 may be curved such as a convex curved surface or a recessed curved surface. In this case, the “bidimensionally disposed” means being disposed on a curved surface, for example, being disposed at a position represented by two independent coordinate axes on a curved surface by cylindrical coordinates, spherical coordinates, or the like. The light source 3 has an optical axis in the normal direction of the substrate 2. A portion of the substrate 2 not covered with the reflector 4 (portion exposed through a hole 4b to be described below) or the entire surface of the substrate 2 is subjected to a treatment for increasing the reflectance of light.

In an actual product, a lens array, a diffuser, and various optical sheets are disposed at an upper side (emission side) of the reflector 4 in the drawing, and the lens array, the diffuser, and the optical sheets are often housed in a frame (provided with an opening at the emission side) made of metal, resin, or the like. Examples of the optical sheet include a prism sheet (prism film), a luminance enhancement sheet (luminance enhancement film), and a louver sheet (louver film).

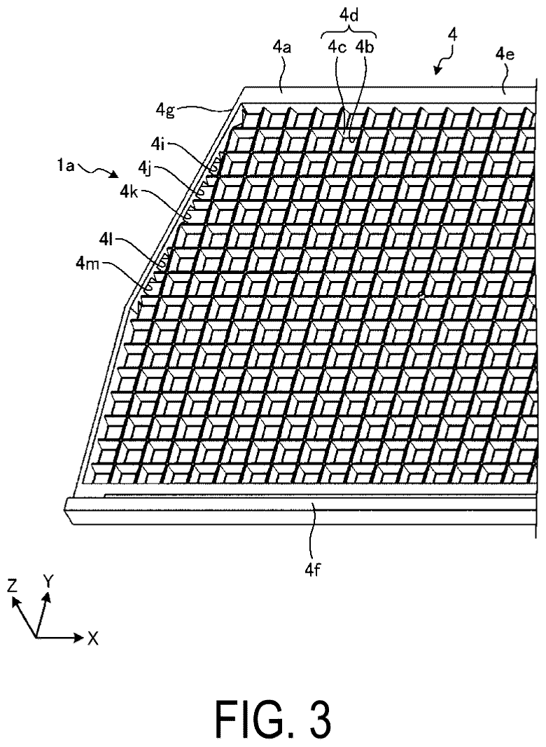

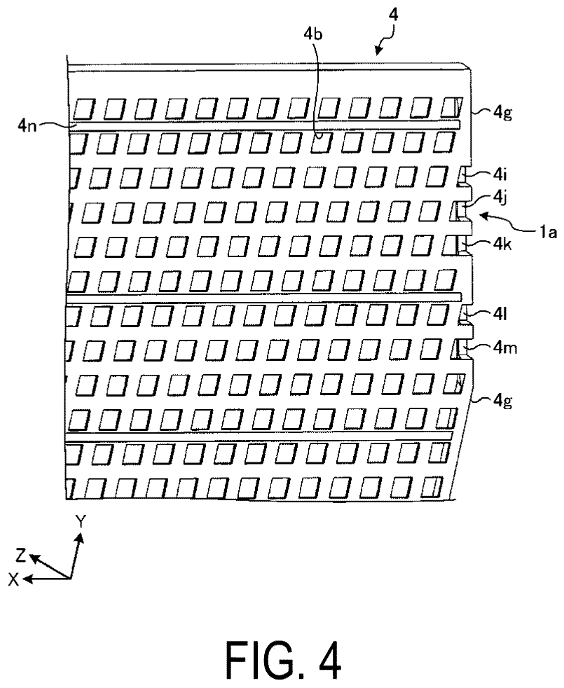

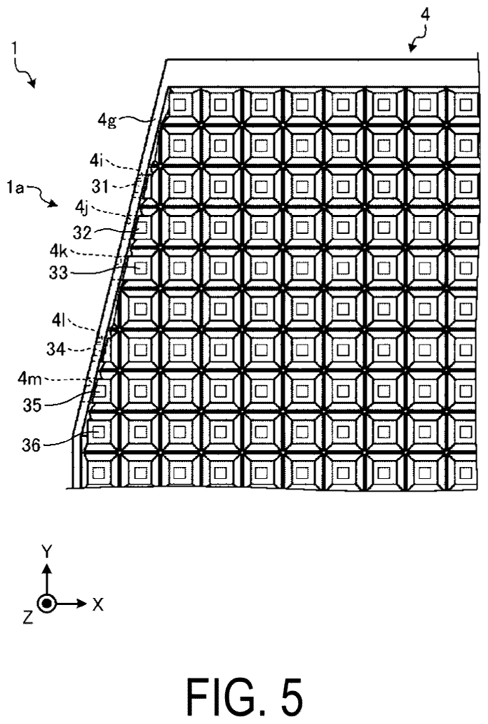

FIG. 3 is an enlarged perspective view of the vicinity of the cutout portion 1a of the reflector 4. FIG. 4 is an enlarged perspective view of the vicinity of the cutout portion 1a of the reflector 4 viewed from another viewpoint. FIG. 5 is a view from a direction facing an emission surface in the vicinity of the cutout portion of the planar illumination device 1.

In FIGS. 3 to 5, the reflector 4 has outer walls 4e, 4f, 4g, and 4h (the outer wall 4h is not illustrated) serving as outer peripheral portions. In FIG. 4, a recessed portion 4n is a portion disposed with a double-sided tape for attaching the reflector 4 to the substrate 2.

In FIGS. 3 to 5, the reflector 4 has a segment 4d provided corresponding to each light source 3 (FIG. 2). The segment 4d has a hole 4b, and a reflecting surface 4b extending obliquely from the periphery of the hole 4b and surrounding the light source 3, a head of the light source 3 being inserted into the hole 4b. In the illustrated example, the segment 4d is formed in a rectangular shape, and the reflecting surface 4c is divided into four. That is, the light source 3 has a substantially rectangular outer shape in a plan view, a predetermined shape of the segment is substantially rectangular in the plan view, the hole 4b in the predetermined shape of the segment has a substantially rectangular outer shape in a plan view, and the reflecting surface 4c in the predetermined shape of the segment is constituted by four planes. Part or all of the reflecting surfaces may be constituted by two or more surfaces. For example, when each of all the reflecting surfaces is constituted by two surfaces, the total number of surfaces is 8.

In the cutout portion 1a having the irregular outer shape, for a column of the segments extending in a vertical direction at the left end of FIG. 3, no segments are disposed in six rows from the upper side of the drawing, and segments are disposed in two rows below the six rows although the segments do not have a regular predetermined shape. In these segments, recessed portions 4l and 4m for accommodating the light sources 3 are provided at the surface of the outer wall 4g of the reflector 4 opposing the substrate 2 (back surface in FIG. 3). The recessed portions 41 and 4m are provided through the outer wall 4g can be provided with adequate widths sufficient to accommodate light sources 34 and 35 (FIG. 5) even when the outer wall 4g is not thick enough.

For the second column from the left end of FIG. 3, no segments are disposed in two rows from the upper side of the drawing, and segments are disposed in three rows below the two rows although the segments do not have a regular predetermined shape. In the segments, recessed portions 4i, 4j, and 4k are provided at the surface of the outer wall 4g of the reflector 4 opposing the substrate 2 (back surface in FIG. 3). Among the three recessed portions 4i, 4j, and 4k, two recessed portions 4i and 4j are provided to accommodate light sources 31 and 32 (FIG. 5). The remaining recessed portion 4k is provided to adjust the amount of light.

That is, in the segment provided with the recessed portion 4k, the outer wall 4g does not interfere with the arrangement of a light source 33 (FIG. 5), but the area of the segment is reduced, the segment as it is has an increased amount of light per area to be brighter, and thus part of the light is consumed by the recessed portion 4k to adjust the amount of light. In this regard, although a segment of a light source 36 (FIG. 5) does not have a regular predetermined shape, the area of the segment is less reduced, and the amount of light per area is less affected, thus providing no recessed portion.

Although the reflector 4 is made of, for example, a white resin or the like having a high reflectance, the material of the recessed portions 4i to 4m may be exposed or the reflectance may be changed by coloring or the like.

In this way, as for a portion where the light source 3 is not arrangeable due to an interference of the outer wall 4g even in an irregular portion where a segment (standard segment) 4d having a predetermined outer shape is not arrangeable due to the irregular outer shape of the cutout portion 1a, the recessed portions 4i, 4j, 4l, and 4m are provided at the surface of the outer wall 4g opposing the substrate 2, thus allowing the light sources 31, 32, 34, and 35 to be disposed to arrange segments. This can eliminate a decrease in the luminance of the outer peripheral portion of an irregular portion and prevent a dark portion from being formed.

Eliminating the outer wall 4i is conceivable instead of providing the recessed portions 4i, 4j, 4l, 4m, and the like, but the strength of the reflector 4 is decreased, and light from the light sources 31, 32, 34, 35, and the like is too strong and rather impairs the uniformity of luminance. That is, the recessed portions 4i, 4j, 4l, and 4m blocking light emitted directly above the light sources 31, 32, 34, and 35 can reduce the light emission efficiency per area can and improve the uniformity in a light emission surface.

As in the segment of the light source 33, the outer wall 4g does not interfere with the arrangement of the light sources 33, but the recessed portion 4k as described above is used to adjust the amount of light per area.

To compensate for a shortage of the amount of light due to an incomplete region where no segment is arrangeable, such as a region on the segment of the light source 34 in the drawing, the recessed portion 4l in the segment of the light source 34 can be enlarged to the upper side of the drawing. In this case, light is guided from the light source 34 to the incomplete region where no segment is arrangeable, allowing for compensating for a shortage of the amount of light.

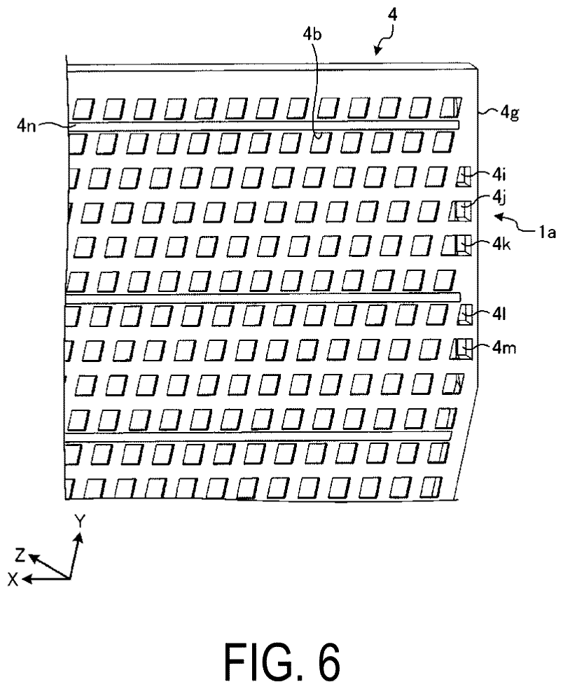

FIG. 6 is a perspective view illustrating an example provided with the recessed portions 4i to 4m without extending through the outer wall 4g of the reflector 4. FIG. 6 is a view from the same viewpoint as in FIG. 4. In FIG. 6, the outer wall 4g of the reflector 4 is formed thicker, and the recessed portions 4i, 4j, 4k, 4l, and 4m do not extend through the outer wall 4g.

The recessed portions 4i, 4j, 4k, 4l, and 4m not extending through the outer wall 4g allows the thickness of the outer wall 4g to be maintained and the reduction of the strength of the reflector 4 to be prevented. Other effects are the same as the effects of the configuration example described above. A space for disposing light sources is provided above the recessed portion 4i in the drawing or above the recessed portion 4l in the drawing, and segments and recessed portions may be provided at the portion. In this case, the recessed portions may extend through the outer wall 4g as illustrated in FIG. 4 when the thickness of the outer wall 4g is insufficient.

In the examples of FIGS. 1 to 6, the reflector 4 is disposed on the substrate 2 so that the surface (grating surface) on a non-emission side contacts the substrate 2, but only the outer walls 4e to 4h of the reflector 4 or part of the outer walls 4e to 4h contact the substrate 2, and the hole 4b of the segment 4d may be made to be floating from the substrate 2. In this case, the head of the light source 3 disposed on the substrate 2 may or may not be inserted into the hole 4b of the segment 4d. When the head of the light source 3 is not inserted into the hole 4b of the segment 4d, the reflector 4 and the light source 3 are prevented from interfering with each other even though the reflector 4 and the light source 3 expand or contract due to a temperature change. When the head of the light source 3 is not inserted into the hole 4b of the segment 4d, the size of the hole 4b of the segment 4d in a plan view may be larger than the light-emitting portion of the light source 3 (for example, a light-emitting portion having a rectangular shape is provided inside the rectangular outer shape of the light source 3) or may be smaller than the outer shape of the light source 3. In this case, even though the light sources 3 are disposed at a small pitch and the segments 4d of the reflector 4 are disposed at a high density, the reflector 4 can be easily manufactured by injection molding or the like, a height of a wall constituting the reflecting surface 4c of the segment 4d can be increased (the thickness in the Z-axis direction can be increased), reflection efficiency is improved, and emission of light to adjacent segments 4d is suppressed to improve contrast during local dimming. Such a structure of the reflector 4 can also be similarly applied to the following embodiments.

### Second Embodiment

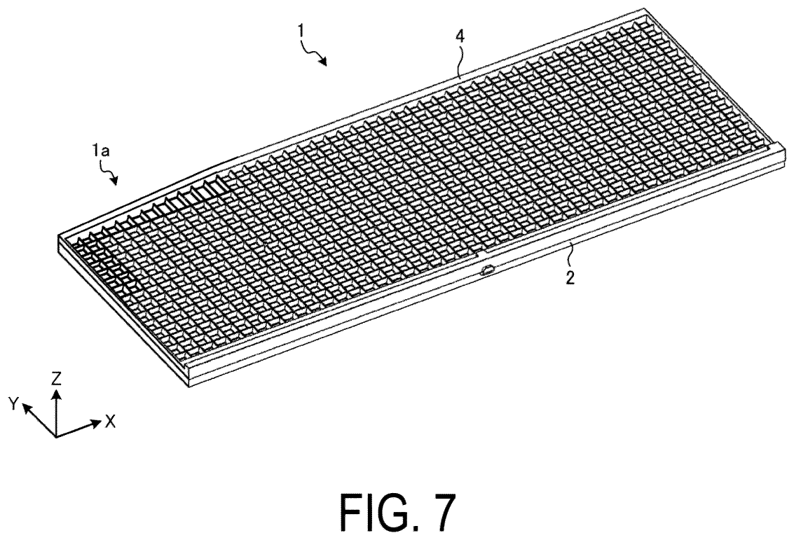

FIG. 7 is a perspective view of a planar illumination device 1 according to a second embodiment. For the sake of convenience, a longitudinal direction of the planar illumination device 1 is an X-axis direction, a lateral direction is a Y-axis direction, and a thickness direction is a Z-axis direction, but an orientation during use is arbitrary.

In FIG. 7, the planar illumination device 1 includes a substrate 2 and a reflector 4 fixed to an upper side of the substrate 2 in the drawing by a double-sided tape or the like. In FIG. 7, light sources 3 on the substrate 2 are not illustrated. A cutout portion 1a is provided at the upper left side of the substrate 2 and the reflector 4 in the drawing to form an irregular outer shape. The irregular outer shape may not only be chipped in a linear shape like the cutout portion 1a but also be chipped in an arc shape or in a complicated shape.

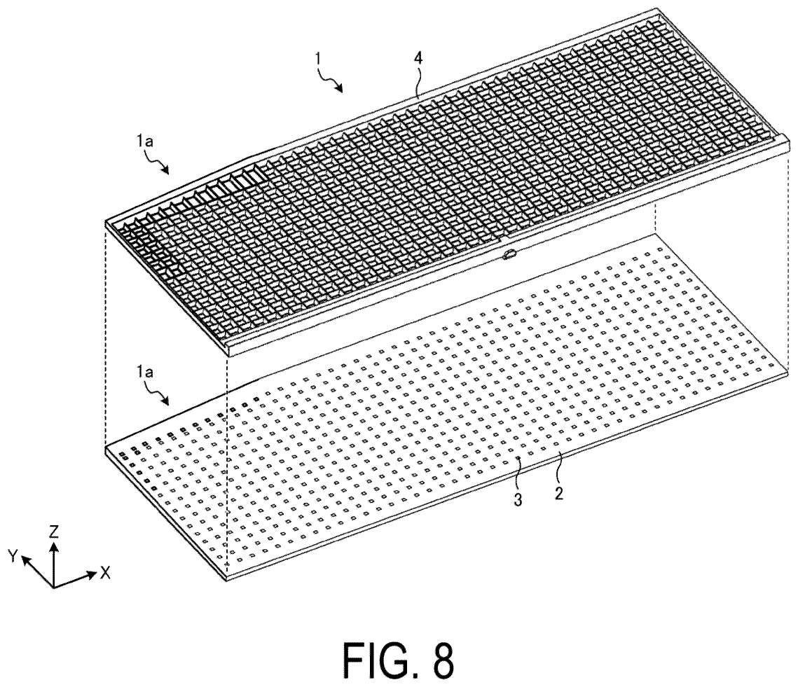

FIG. 8 is an exploded perspective view of the planar illumination device 1. In FIG. 8, the light sources 3 such as light-emitting diodes (LEDs) are bidimensionally disposed on the substrate 2, and wiring (not illustrated) to each light source 3 is also provided. Although the substrate 2 and the reflector 4 each have a flat plate shape in the illustrated example, the substrate 2 and the reflector 4 may be curved such as a convex curved surface or a recessed curved surface. In this case, the “bidimensionally disposed” means being disposed on a curved surface, for example, being disposed at a position represented by two independent coordinate axes on a curved surface by cylindrical coordinates, spherical coordinates, or the like. The light source 3 has an optical axis in the normal direction of the substrate 2. A portion of the substrate 2 not covered with the reflector 4 (portion exposed through a hole 4b to be described below) or the entire surface of the substrate 2 is subjected to a treatment for increasing the reflectance of light.

In an actual product, a lens array, a diffuser, and various optical sheets are disposed at an upper side (emission side) of the reflector 4 in the drawing, and the entire product is often housed in a frame (provided with an opening at the emission side) made of metal, resin, or the like. Examples of the optical sheet include a prism sheet (prism film), a luminance enhancement sheet (luminance enhancement film), and a louver sheet (louver film).

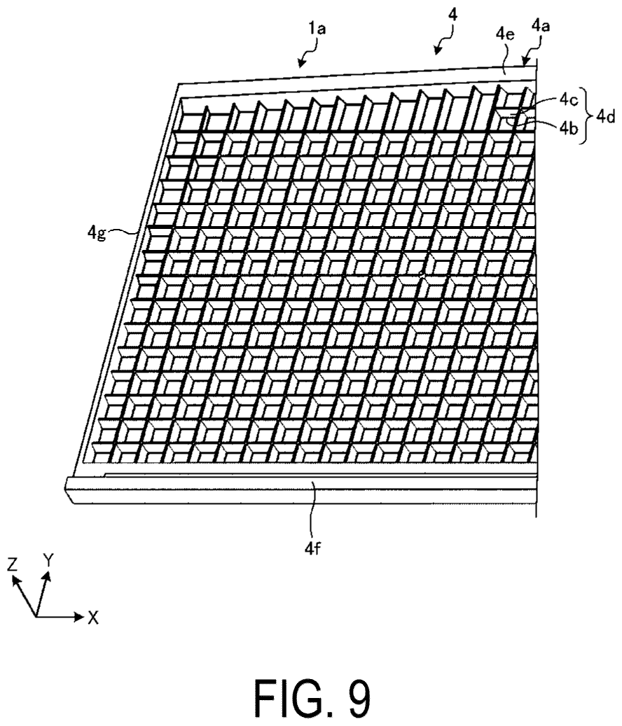

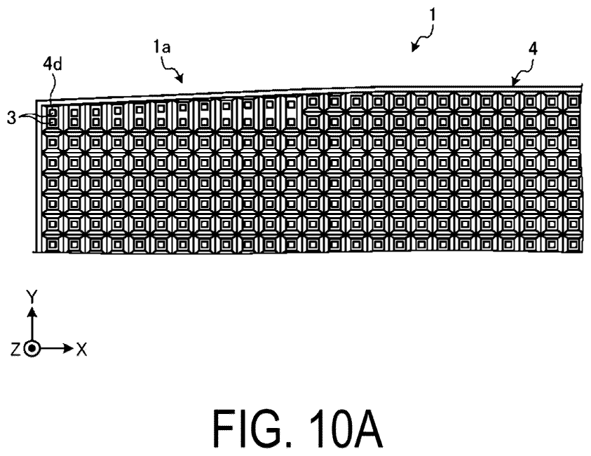

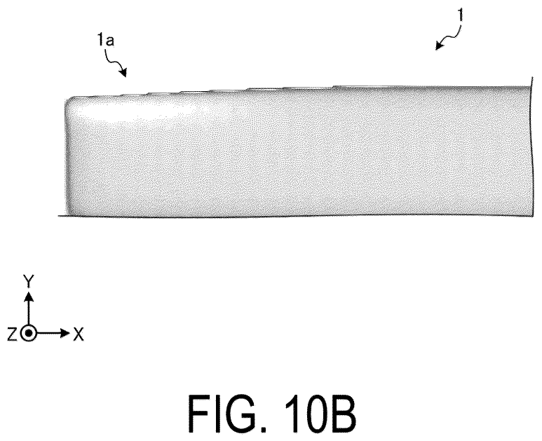

FIG. 9 is an enlarged perspective view of the vicinity of the cutout portion 1a of the reflector 4. FIG. 10A is a plan view illustrating the vicinity of the cutout portion 1a of the planar illumination device 1.

In FIGS. 9 and 10A, the reflector 4 has outer walls 4e, 4f, 4g, and 4h (the outer wall 4h is not illustrated) serving as outer peripheral portions. The reflector 4 has a segment 4d provided corresponding to each light source 3. The segment 4d has a hole 4b, and a reflecting surface 4b extending obliquely from the periphery of the hole 4b and surrounding the light source 3, a head of the light source 3 being inserted into the hole 4b. The outer walls 4e, 4f, 4g, and 4h need not to be provided over the entire circumference of an entire outer peripheral portion, may be partially provided, or may not be provided anywhere.

In the illustrated example, the segment 4d is formed in a rectangular shape, and the reflecting surface 4c is divided into four. The light source 3 has a substantially cubic outer shape. That is, the light source 3 has a substantially rectangular outer shape in the plan view, the standard shape of the segment excluding an irregular portion is a substantially rectangular shape in a plan view, the hole 4b of the segment has a substantially rectangular outer shape in the plan view, and the reflecting surface 4c of the segment is constituted by four planes. Part or all of the reflecting surfaces may be constituted by two or more surfaces. For example, when each of all the reflecting surfaces is constituted by two surfaces, the total number of surfaces is 8. Hereinafter, the segment having the standard shape excluding the irregular portion is also referred to as a standard segment. In the present embodiment, a plurality of standard segments 4d is lined in a regular manner (in a grid pattern) in row and column directions.

In the cutout portion 1a having an irregular outer shape, a segment group for improving uniformity is disposed instead of the standard segment. That is, in 12 columns from the upper left end of the first row to the right side in the drawing, segments disposed in two rows with no irregular shape are integrated by removing a partition wall between the two rows. In other words, the segment 4d having an irregular shape and a segment 4d adjacent to the segment 4d (not necessarily the standard segment 4d) are integrated by removing a partition wall (reflecting surface 4c) forming the boundary between the two segments 4d. The segment 4d having an irregular shape is a (virtual) segment having a the hole 4b smaller than the hole of the standard segment 4d with at least one side of the hole 4b along the outer shape of the whole (irregular portion). A plurality of (two) light sources 3 or a larger number of light sources 3 than the number of light sources 3 accommodated in the standard segment 4d is accommodated in the hole 4b of each segment 4d. In the holes 4b of the segments 4d, the light sources 3 are vertically spaced apart from each other. Depending on the shape and size of the segment 4d having an irregular shape, a space with the partition wall (reflecting surface 4c) can also be utilized as a space for accommodating the light sources 3. The other segments 4d are disposed so that light emission centers of the light sources 3 are located at the centers. The light emission center corresponds to a position of a minute light-emitting chip incorporated in the light source 3, and does not necessarily coincide with the center of the package of the light sources 3. When a plurality of light-emitting chips is mounted, an average position of the light-emitting chips serves as a light emission center. FIG. 10B is a view illustrating an example of a luminance distribution of the planar illumination device 1 in FIG. 10A. The characteristics of the planar illumination device 1 are described below. Even though the arrangement positions of the light sources 3 are changed depending on the size or the like of the segment 4d having an irregular shape to be integrated, the number of light sources 3 to be accommodated may not exceed the number of light sources 3 to be accommodated in the standard segment 4d. Three or more segments 4d may be integrated or may not be integrated with an adjacent segment 4d depending on the size or the like of the segment 4d having an irregular shape.

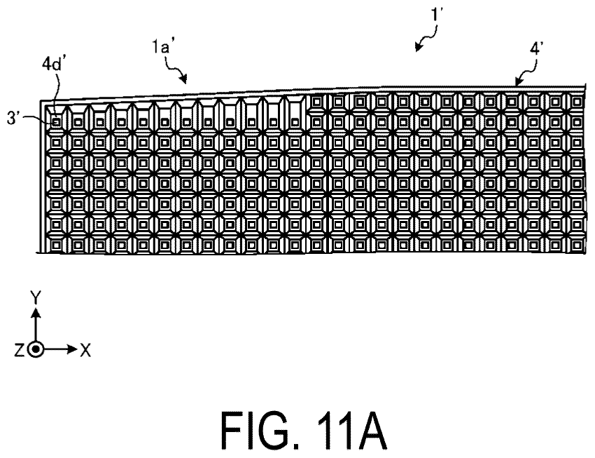

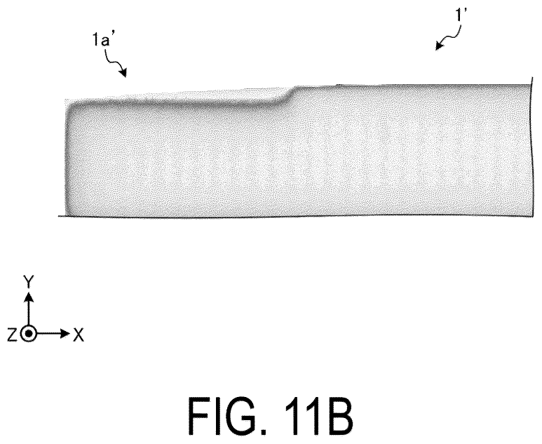

On the other hand, FIG. 11A is a plan view illustrating the vicinity of a cutout portion 1a′ of a planar illumination device 1′in a comparative example (modified example). The cutout portion 1a′ in the planar illumination device 1′in the comparative example of FIG. 11A is similar to that in FIG. 10A in that for twelve columns from the upper left end of the first row to the right side, two rows of segments with no irregular shape are integrated by removing a partition wall between the two rows. However, in the comparative example of FIG. 11A, one light source 3′is disposed at the position of the original second row in a hole of each segment 4d′ of an irregular portion. FIG. 11B is a view illustrating an example of a luminance distribution of the planar illumination device 1′in FIG. 11A, and a dark portion is formed at an outer peripheral portion of the irregular portion. That is, in some irregular portions, an area of the segment 4d′ is too large to be covered with one light source 3′. As a result, a dark portion may be formed at the outer peripheral portion of the cutout portion 1a′ and luminance may not be uniform.

In this regard, in the embodiment of FIGS. 7, 8, 9, and 10A, as illustrated in FIG. 10B, although the luminance is slightly high at the left side portion in the drawing where the light sources 3 are densely disposed, no dark portion is formed at the peripheral portion. The dark portion needs not to be corrected, but a bright portion can be corrected by an optical sheet or the like disposed at the emission surface side of the reflector 4. For example, performing a process of decreasing a light transmittance on a portion of an optical sheet corresponding to a portion to be a bright portion can decrease the luminance of the bright portion and improve the overall luminance uniformity. For example, adjusting the amount of light emission by adjusting a current to be applied to the light source 3 can decrease the luminance of the bright portion and improve the overall luminance uniformity. For example, disposing a black light absorbing member at part of the segment 4d can decrease the luminance of the bright portion and also improve the overall luminance uniformity.

### Third Embodiment

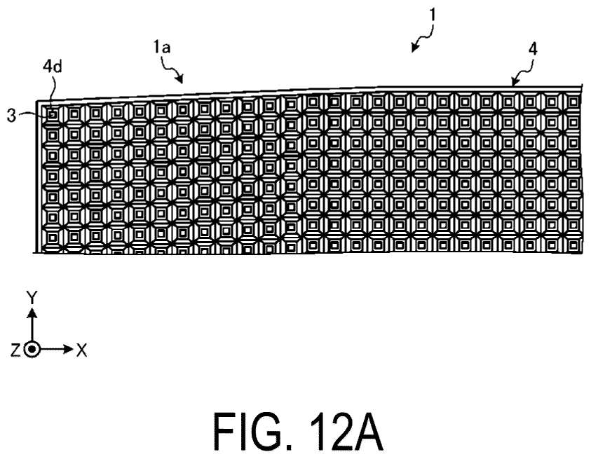

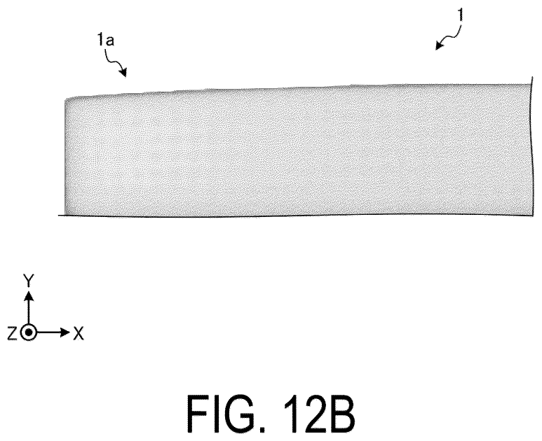

FIG. 12A is a plan view illustrating the vicinity of a cutout portion 1a of a planar illumination device 1 according to a third embodiment. In FIG. 12A, segments 4d disposed in a predetermined region (from the first row to about the fourth row from the top) including the cutout portion 1a having an irregular outer shape are equalized in shape and size. The predetermined region to be equalized is changed in accordance with an aspect of the irregular shape and may be an entire surface or a localized surface. The equalization does not mean that shapes and sizes are exactly the same but that the shapes and sizes are adjusted to be approximated as much as possible. Specifically, for example, in FIG. 12A, the size from the side of the upper end of a reflector 4 including the cutout portion 1a to the upper end of the lower fifth row excluding the width of an outer wall is divided into four equal parts, and segments 4d corresponding to four rows are disposed in the four equal parts. The other configurations are the same as the configurations in FIGS. 7 to 9.

FIG. 12B is a view illustrating an example of a luminance distribution of the planar illumination device 1 in FIG. 12A, and the luminance uniformity in the vicinity of the cutout portion 1a is improved as compared with the first embodiment of FIG. 10B.

### Fourth Embodiment

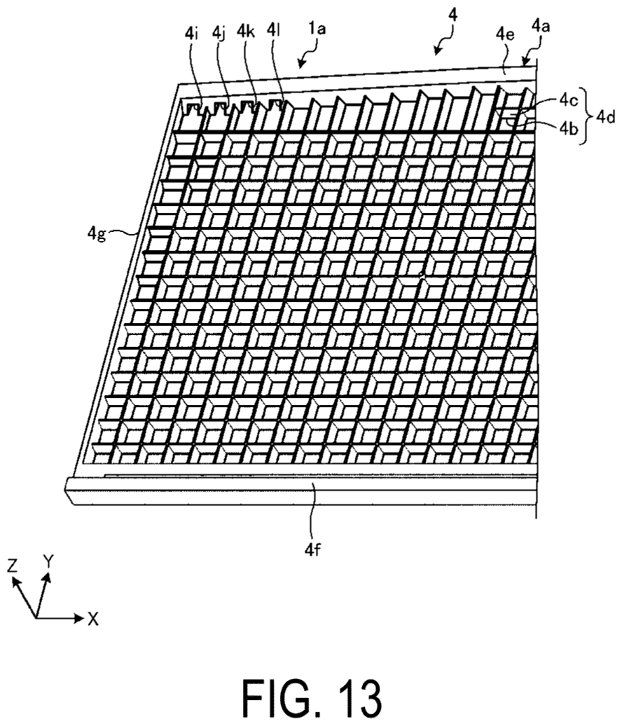

FIG. 13 is a perspective view illustrating the vicinity of a cutout portion 1a of a planar illumination device 1 according to a fourth embodiment with improvements added to the second embodiment of FIG. 9. Similar improvements may also be made to the third embodiment of FIG. 12A.

In FIG. 13, in the vicinity of the cutout portion 1a of a reflector 4, recessed portions 4i, 4j, 4k, and 4l for accommodating light sources 3 or adjusting the amount of light of the light sources 3 are provided at the surface of an outer wall 4e opposing a substrate 2 (back surface in the drawing), as in the first embodiment. The recessed portions 4i, 4j, 4k, and 4l may or may not extend to an upper end part of the outer wall 4e in the drawing depending on the width of the outer wall 4e. The reflector 4 is made of, for example, a white resin or the like having a high reflectance; however, the recessed portions 4i, 4j, 4k, and 4l may be formed so that the material of the recessed portions 4i, 4j, 4k, and 4l may be exposed or the reflectance of the surfaces of the recessed portions 4i, 4j, 4k, and 4l may be changed by coloring or the like. The other configurations are the same as the configurations in FIGS. 7 to 9.

That is, when the size of a segment 4d is not sufficiently securable by the cutout portion la, a plurality of (two) light sources 3 may be difficult to be disposed; however, since light sources 3 can be disposed to be partially hidden below the recessed portions 4i, 4j, 4k, and 4l, a space for disposing the light sources 3 is easily secured. Disposing a plurality of (two) light sources 3 in a narrow segment 4d increases the amount of light per area to increase the luminance (as described above with reference to FIG. 10B); however, the outer wall 4e serves as a cover for the light sources 3 partially inserted and disposed in the recessed portions 4i, 4j, 4k, and 4l and blocks light emitted directly above to allow the amount of light to be suppressed, and thus the luminance can be prevented from increasing more than necessary. As a result, the luminance uniformity can be improved.

### Fifth Embodiment

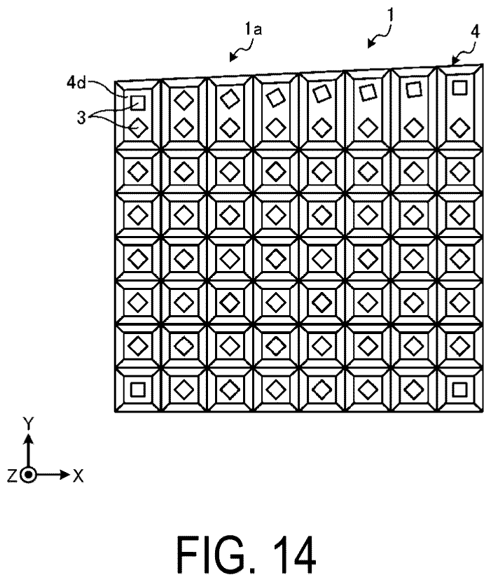

FIG. 14 is a plan view of a planar illumination device 1 according to a fifth embodiment. The illustration of the outer wall of the reflector 4 is omitted. As in FIGS. 7 and 8, a substrate 2 is provided on the back surface of the reflector 4, and light sources 3 are disposed on the substrate 2. Although the disclosure is applied to a case where a plurality of (two) light sources 3 is accommodated in a segment 4d at the side of the cutout portion 1a as in FIG. 10A, the disclosure can also be similarly applied to a case where one light source 3 is accommodated in an equalized segment 4d as in FIG. 12A.

In FIG. 14, a plurality of (two) light sources 3 is accommodated in a segment 4d of the first row at the side of the cutout portion 1a of the reflector 4, as in the second embodiment of FIG. 10A. Furthermore, light sources 3 at four corners of the entire reflector 4 are disposed with a rotation angle of 0° in a plane parallel to the reflector 4 and the substrate 2 while four sides around each light source 3 coincide with or are orthogonal to the X-axis or the Y-axis. Furthermore, the light source 3 disposed between corners at both ends in the segment 4d of the first row at the side of the cutout portion 1a has a rotation angle continuously changed from the right corner. The other light sources 3 are disposed at a rotation angle of 45°.

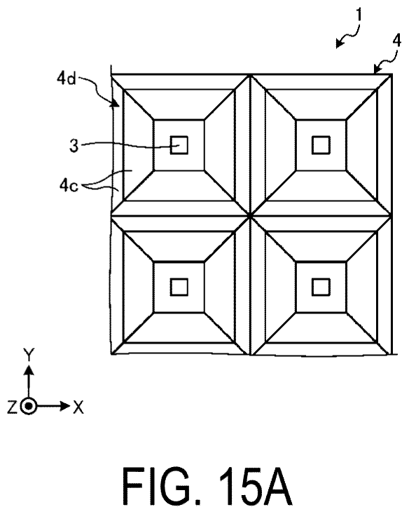

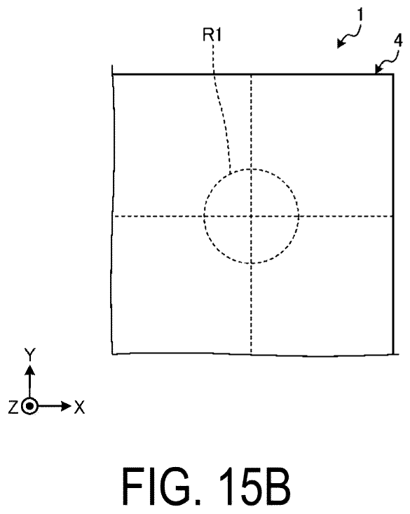

FIG. 15A is a plan view illustrating an example when the rotation angle of the light source 3 of the planar illumination device 1 in the plane is 0°. The illustration of the outer wall of the reflector 4 is omitted. The light source 3 has a substantially cubic (or substantially rectangular parallelepiped) package outer shape, and mainly emits light from four side surfaces provided with phosphors. Therefore, the light-emitting direction has anisotropy, and the amount of light in the front direction of each of the four side surfaces increases. In FIG. 15A, since the rotation angle of the light sources 3 in the plane is 0°, the amount of light in the X-axis direction and the Y-axis direction increases. Since the reflecting surface 4c of the segment 4d is constituted by a plurality of planes divided by diagonal lines in the illustrated example, reflection is also anisotropic. As a result, light is likely to gather at the corners of each segment 4d, and the luminance of the corners increases. FIG. 15B is a view illustrating characteristics of a luminance distribution in the arrangement of FIG. 15A, and the luminance of a region RI where the corners of four segments RI gather becomes high, causing non-uniform luminance.

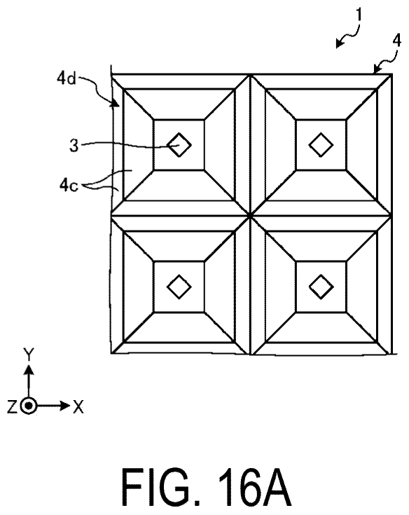

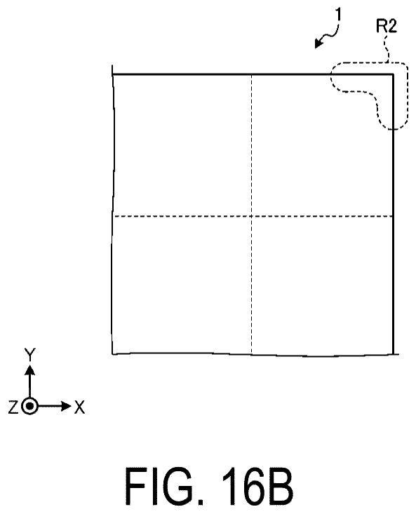

On the other hand, FIG. 16A is a plan view illustrating an example when the rotation angle of the light source 3 of the planar illumination device 1 in the plane is 45°. The illustration of the outer wall of the reflector 4 is omitted. FIG. 16B is a view illustrating characteristics of a luminance distribution in the arrangement of FIG. 16A, and since the relative rotation angle between the light source 3 and the reflecting surface 4c is changed by 45°, the luminance of a portion where the corners of four segments 4d gather becomes low. However, the luminance of a region R2 of a corner of the whole is decreased, causing non-uniform luminance. This is because the corner portion of the whole includes no segments adjacent in two directions, and thus the luminance is originally likely to be low. In this regard, in the arrangement of FIG. 15A, a decrease in luminance is alleviated because the corners of each segment 4d become bright, but in the arrangement of FIG. 16A, a decrease in luminance becomes remarkable because the decrease in luminance is not alleviated.

For these reasons, to suppress a decrease in luminance at the whole corner, the planar illumination device 1 of FIG. 14 has the rotation angle of the light source 3 at the corner portion of the whole of 0°. The rotation angle of the light sources 3 is set to 45° except for the side of the cutout portion 1a so that the luminance of a portion where the corners of four segments 4d gather does not become high. As for the light sources 3 disposed in the segment 4d except for the corner portions of the whole, both ends at the side of the cutout portion 1a, the rotation angle is continuously changed from the light sources 3 at the right end. This is because an area of the segment 4d is larger at the right side than at the left side and the relative amount of light at the right side is smaller, so the brightness of the corners of the segment 4d needs to be secured toward the right side.

### Sixth Embodiment

The change in the rotation angle of the light source 3 in the plane can also be applied to a case including no irregular portion such as the cutout portion 1a.

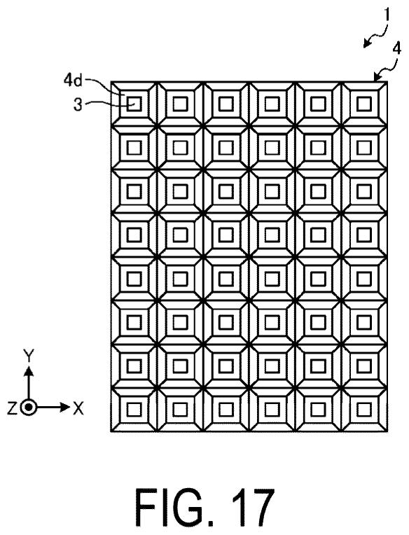

FIG. 17 is a plan view illustrating an example when rotation angles of all light sources 3 of a planar illumination device 1 in a plane are 0°. The illustration of the outer wall of the reflector 4 is omitted. In this case, as described with reference to FIGS. 15A and 15B, a decrease in the luminance at the corner portion of the whole is alleviated to some extent, but the luminance at a portion where the corners of four inner segment 4d gather becomes high and the luminance uniformity decreases.

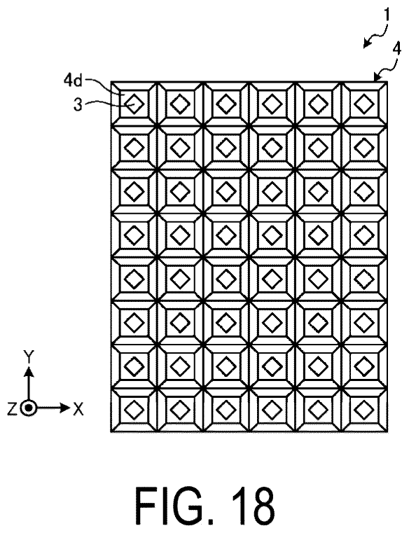

FIG. 18 is a plan view illustrating an example when the rotation angles of all the light sources 3 of the planar illumination device 1 in the plane are 45°. The illustration of the outer wall of the reflector 4 is omitted. In this case, as described with reference to FIG. 16A and FIG. 16B, an increase in the luminance of a portion where the corner portions of four inner segments 4d gather is suppressed, but a decrease in the luminance of the corner portion of the whole becomes significant and the luminance uniformity decreases.

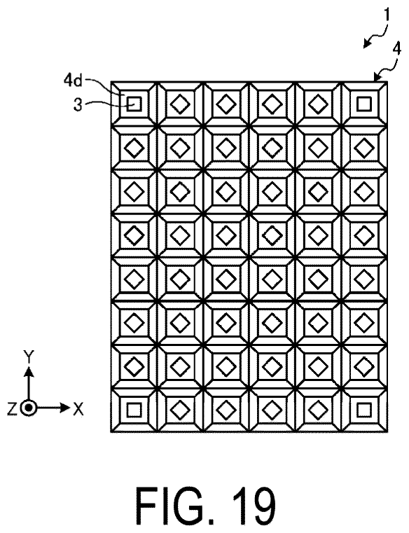

FIG. 19 is a plan view illustrating an example when the rotation angles of the light sources 3 at the corner portion of the whole of the planar illumination device 1 in the plane are 0° and the rotation angles of the other light sources 3 in the plane are 45°. The illustration of the outer wall of the reflector 4 is omitted. In this case, a decrease in luminance at the corner portion of the whole is alleviated to some extent, and an increase in luminance at a portion where four inner segments 4d gather is suppressed.

### Seventh Embodiment

The pattern of the shape of a reflecting surface 4c of a segment 4d of a reflector 4 is described below. Although the rotation angle of a light source 3 in a plane is set to 0° in the following drawings, the rotation angle of the light source 3 can be changed on the basis of the principle described above.

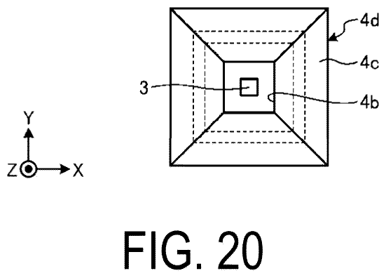

FIG. 20 is a plan view illustrating an example of the shape of the reflecting surface 4c of the segment 4d of the reflector 4, and illustrates a case where the reflecting surface 4c is constituted by a plurality of planes divided by diagonal lines of the segment 4d having a rectangular shape, as described above. Broken lines in the drawing indicate contour lines of the shape.

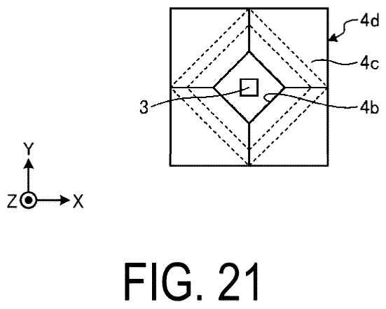

FIG. 21 is a plan view illustrating another example of the shape of the reflecting surface 4c of the segment 4d of the reflector 4, and illustrates a case where the reflecting surface 4c is constituted by a plurality of planes divided by vertical and horizontal cross lines. In this case, the relative rotation angle between the anisotropy of the light source 3 and the anisotropy of the segment 4d is the same as in FIG. 16A, and the effects are also the same.

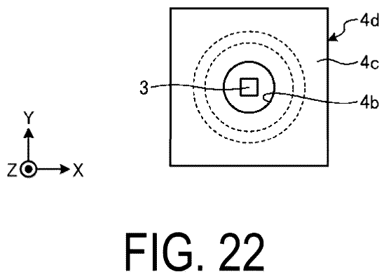

FIG. 22 is a plan view illustrating another example of the shape of the reflecting surface 4c of the segment 4d of the reflector 4, and illustrates a case where the reflecting surface 4c is constituted by a conical curved surface. In this case, the anisotropy of the segment 4d is eliminated or reduced, and only the anisotropy of the light source 3 remains.

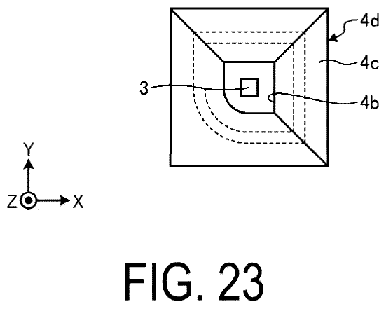

FIG. 23 is a plan view illustrating another example of the shape of the reflecting surface 4c of the segment 4d of the reflector 4, and illustrates a case where one region partitioned by one diagonal line is constituted by a plurality of planes divided by other diagonal lines and the other region is constituted by a conical curved surface to constitute the reflecting surface 4c. In this case, the anisotropy of the segment 4d is eliminated or reduced in the other region, and only the anisotropy of the light source 3 remains.

By combining the shape patterns of the reflecting surfaces 4c in FIGS. 20 to 23 described above and the rotation angle of the light sources 3 in the plane, the luminance can be variously changed.

The embodiments of the disclosure have been described above, but the disclosure is not limited to the embodiments described above, and various modifications are possible without departing from the spirit of the disclosure.

As described above, the planar illumination device according to the embodiment includes a plurality of light sources, a substrate with the light sources bidimensionally disposed and a reflector provided with a segment including a hole corresponding to each of the light sources and a reflecting surface extending obliquely from a periphery of the hole, provided with outer walls at an entire outer peripheral portion of the reflector, the reflector being disposed at an emission side of the substrate. In the segment disposed at an irregular portion of an outer peripheral portion of the reflector and unconfigurable into a predetermined shape by the outer walls, surfaces of the outer walls opposing the substrate are provided with recessed portions for accommodating the light sources or adjusting an amount of light. This allows a dark portion to be less likely to be formed even when the planar illumination device has an irregular outer shape.

The recessed portions are provided through the outer wall. This can provide, even when the thickness of the outer wall is not sufficient, a recessed portion having an adequate width sufficient to accommodate the light source.

The recessed portions are provided without extending through the outer wall. This can cope with a sufficient thickness of the outer wall and prevent a decrease in the strength of the reflector.

The light source has a substantially rectangular outer shape in a plan view, the predetermined shape of the segment is substantially rectangular in a plan view, the hole in the predetermined shape of the segment has a substantially rectangular outer shape in the plan view, and the reflecting surface in the predetermined shape of the segment is constituted by a plurality of planes. This can embody the structure of the planar illumination device.

A segment group for improving uniformity disposed at the irregular portion of the outer peripheral portion of the reflector is provided. This can maintain, even when the planar illumination device has an irregular outer shape, luminance uniformity.

In the segment group, a segment having an irregular shape and a segment adjacent to the segment are integrated by removing a partition at a boundary between the two segments. This can constitute a segment suitable for an irregular portion. This can also increase a space for accommodating the light source.

Provided are a plurality of light sources, a substrate with the light sources bidimensionally disposed, a reflector provided with a segment including a hole corresponding to each of the light sources and a reflecting surface extending obliquely from a periphery of the hole, the reflector being disposed at an emission side of the substrate, and a segment group for improving uniformity disposed at an irregular portion of an outer peripheral portion of the reflector. This can maintain, even when the planar illumination device has an irregular outer shape, luminance uniformity.

In the segment group, a segment having an irregular shape and a segment adjacent to the segment are integrated by removing a partition at a boundary between the two segments. This can constitute a segment suitable for an irregular portion. Furthermore, a space for accommodating the light source can be increased.

Moreover, the disclosure is not limited to the embodiments described above. A configuration obtained by appropriately combining the above-mentioned constituent elements is also included in the disclosure. Further effects and modified examples can be easily derived by a person skilled in the art. Thus, a wide range of aspects of the disclosure are not limited to the embodiments described above and may be modified variously.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A planar illumination device, comprising:
a plurality of light sources;
a substrate with the light sources bidimensionally disposed; and
a reflector provided with a segment including a hole corresponding to each of the light sources and a reflecting surface extending obliquely from a periphery of the hole, provided with outer walls at an entire outer peripheral portion of the reflector, the reflector being disposed at an emission side of the substrate, wherein
in the segment disposed at an irregular portion of an outer peripheral portion of the reflector and unconfigurable into a predetermined shape by the outer walls, surfaces of the outer walls opposing the substrate are provided with recessed portions for accommodating the light sources or adjusting an amount of light.

2. The planar illumination device according to claim 1, wherein the recessed portions are provided through the outer walls.

3. The planar illumination device according to claim 1, wherein the recessed portions are provided without extending through the outer walls.

4. The planar illumination device according to claim 1, wherein
the light sources each have a substantially rectangular outer shape in a plan view,
the predetermined shape of the segment is substantially rectangular in a plan view,
the hole in the predetermined shape of the segment has a substantially rectangular outer shape in a plan view, and
the reflecting surface in the predetermined shape of the segment is constituted by a plurality of planes.

5. The planar illumination device according to claim 1, comprising
a segment group for improving uniformity disposed at the irregular portion of the outer peripheral portion of the reflector.

6. The planar illumination device according to claim 5, wherein in the segment group, a segment having an irregular shape and a segment adjacent to the segment are integrated by removing a partition at a boundary between the two segments.

7. A planar illumination device, comprising:
a plurality of light sources;
a substrate with the light sources bidimensionally disposed;
a reflector provided with a segment including a hole corresponding to each of the light sources and a reflecting surface extending obliquely from a periphery of the hole, the reflector being disposed at an emission side of the substrate; and
a segment group for improving uniformity disposed at an irregular portion of an outer peripheral portion of the reflector, wherein
a segment belonging to the segment group accommodates at least one light source of the light sources in the hole.

8. A planar illumination device, comprising:
a plurality of light sources;
a substrate with the light sources bidimensionally disposed;
a reflector provided with a segment including a hole corresponding to each of the light sources and a reflecting surface extending obliquely from a periphery of the hole, the reflector being disposed at an emission side of the substrate; and a segment group for improving uniformity disposed at an irregular portion of an outer peripheral portion of the reflector, wherein in the segment group, a segment having an irregular shape and a segment adjacent to the segment are integrated by removing a partition at a boundary between the two segments.
